(19) United States
(12) Patent Application Publication
(10) Pub. No.: US 2026/0229793 A1
(43) Pub. Date: Aug. 6, 2026

(54) CONNECTION STRUCTURE, BUS BAR, AND CONNECTOR

(71) Applicant: Japan Aviation Electronics Industry, Limited, Tokyo (JP)

(72) Inventor: Takuo SASAKI, Tokyo (JP)

(21) Appl. No.: 19/444,729

(22) Filed: Jan. 9, 2026

(30) Foreign Application Priority Data
Feb. 5, 2025 (JP) 2025-017344
Feb. 5, 2025 (JP) 2025-017415

(51) Int. Cl. H01R 4/34

(52) U.S. Cl. CPC H01R 4/34

(57) ABSTRACT

A connection structure includes a bus bar having a first connection surface, a connection object having a second connection surface, a potting member applied between the first connection surface and the second connection surface, and a bolt fastening the bus bar and the connection object together such that the first connection surface and the second connection surface are pressed against each other, the bus bar including a first base member made of aluminum and a copper piece of plate shape that is joined to the first base member by metallic bonding and that forms the first connection surface, the connection object including a second base member made of aluminum, the second connection surface being formed of the second base member, the first connection surface having a projection projecting toward the second connection surface.

### BACKGROUND OF THE INVENTION

The present invention relates to a connection structure, particularly to a connection structure in which a bus bar using aluminum as its base material and a connection object using aluminum as its base material are connected by bolting.

The present invention also relates to a bus bar used in the connection structure, and a connector having the bus bar.

In general, electrical connection between a motor device and an inverter device that are used in electric vehicles is made by fastening a motor-side bus bar and an inverter-side bus bar together by bolting. As such a bus bar, a bus bar made of copper having a low contact resistance is often used to suppress the amount of heat generated when current is applied between a motor device and an inverter device.

However, since a bus bar made of copper is to be a heavy-weight product and also relatively expensive, it is desired to use aluminum that is light-weight, excellent in electric conductivity, and relatively inexpensive.

For instance, JP 2023-82637 A discloses a connection structure in which a first bus bar 1 including aluminum as its main component and a second bus bar 2 including metal as its main component are fastened together with a bolt 3 and a nut 4 as shown in FIG. 16.

It is known that aluminum is highly reactive with oxygen, and when a conductive member made of aluminum is exposed to outside air, a surface of the conductive member is oxidized, so that an oxide coating is formed on the surface, resulting in a high contact resistance.

To deal with it, in the connection structure of JP 2023-82637 A, hemispherical or columnar projection portions 5 are formed on the surface of the first bus bar 1 facing the second bus bar 2 as shown in FIG. 17. When the first bus bar 1 and the second bus bar 2 are fastened together with the bolt 3 and the nut 4, a compression force is applied to the projection portions 5 in contact with the second bus bar 2, so that the projection portions 5 undergo plastic deformation, whereby an oxide coating 6 formed on the surfaces of the projection portions 5 is broken; consequently, aluminum inside the projection portion 5 makes direct contact with the metal constituting the second bus bar 2.

With the connection structure of JP 2023-82637, by allowing aluminum inside the projection portions 5 to contact the second bus bar 2, the contact resistance between the first bus bar 1 and the second bus bar 2 can be lowered.

However, if the second bus bar 2 includes aluminum as its main component, an oxide coating 6 would be formed also on the surface of the second bus bar 2; therefore, even when the oxide coating 6 on the surfaces of the projection portions 5 of the first bus bar 1 is broken, aluminum inside the projection portions 5 may fail to make direct contact with aluminum constituting the second bus bar 2.

Aside from that, even when aluminum inside the projection portions 5 of the first bus bar 1 makes direct contact with aluminum constituting the second bus bar 2, if the connection structure of JP 2023-82637 is left in the air for a long period of time, an oxide coating would be formed at a contacting portion between the first bus bar 1 and the second bus bar 2, and this may result in an increase in contact resistance.

### SUMMARY OF THE INVENTION

The present invention has been made to solve such conventional problems and is aimed at providing a connection structure capable of connecting, by bolting, a bus bar and a connection object each having a base member made of aluminum, while maintaining a low contact resistance.

The present invention is also aimed at providing a bus bar used in the connection structure, and a connector using the bus bar.

The present inventor fastened two bus bars B1 and B2 of flat plate shape together with a bolt FB as shown in FIG. 1 and measured a contact resistance between the bus bars B1 and B2 with the fastening torque by the bolt FB being varied. Measurement was carried out for three cases where, as the bus bars B1 and B2, bus bars both made of copper were used, bus bars both made of aluminum were used, and one bus bar made of copper and the other bus bar made of aluminum were used.

The measurement results are shown in FIG. 2. In FIG. 2, C1 represents the measurement result of the case where the bus bars B1 and B2 were both made of copper, C2 represents the measurement result of the case where the bus bars B1 and B2 were both made of aluminum, and C3 represents the measurement result of the case where the bus bar B1 was made of copper and the bus bar B2 was made of aluminum.

In all of the measurement results C1 to C3, that is, regardless of the metals of the bus bars B1 and B2, the contact resistance tends to decrease with increasing fastening torque.

As shown in the measurement result C1, when the bus bars B1 and B2 both made of copper are fastened together, the contact resistance is not more than 10 μΩ even with a small fastening torque, and it is found that large current can be applied between the bus bars B1 and B2 without causing problems such as temperature increase.

In contrast, as shown in the measurement result C2, when the bus bars B1 and B2 both made of aluminum are fastened together, the contact resistance is as high as 100 μΩ or thereabout no matter how much a fastening torque is increased. This is probably because strong oxide coatings are formed on the surfaces of the bus bars B1 and B2 both made of aluminum. In this case, it is concerned that application of large current between the bus bars B1 and B2 may cause problems such as heat generation and hence temperature increase.

To cope with it, the bus bar B1 made of copper and the bus bar B2 made of aluminum were fastened together. In this case, as shown in the measurement result C3, it was found that while the contact resistance is several tens of micro-ohms when the fastening torque is small, the contact resistance decreases to 10 μΩ or less with increasing fastening torque, as with the case of the bus bars B1 and B2 both made of copper.

Aside from that, the surface portion of the bus bar B2 made of aluminum which faced the bus bar B1 made of copper was scratched and damaged by a jig having a projection in the shape of a sharp spike, and then the bus bars B1 and B2 were fastened together. In this case, the contact resistance was able to be suppressed to a value still lower than that of the measurement result C3, and the contact resistance was not more than 10 μΩ even with a small fastening torque.

Thus, when the combination of the bus bar B1 made of copper and the bus bar B2 made of aluminum was used, a low contact resistance of not more than 10 μΩ was able to be obtained as an initial property; however, when the combination was left in a high temperature environment at, e.g., 150° C., the contact resistance exceeded 10 μΩ before 100 hours elapse. Hence, some measures against the environmental characteristics are found to be necessary.

The present inventor conducted the above measurements and made an intensive study. As a result, the inventor has conceived the following idea: a bus bar in which a copper piece of plate shape is joined to a first base material made of aluminum by metallic bonding is prepared, a surface of the copper piece is defined as a first connection surface, and a projection is formed on the first connection surface; a second connection surface is formed on a second base member made of aluminum which is a connection object; a potting material is applied between the first connection surface and the second connection surface; and then, the bus bar and the connection object are fastened together with a bolt such that the first connection surface and the second connection surface are pressed against each other. The present inventor has completed the present invention described below by embodying the above idea.

The present invention provides a connection structure in which a first connection surface of a bus bar and a second connection surface of a connection object are connected to each other, the connection structure comprising:
a potting member applied between the first connection surface and the second connection surface; and
a bolt fastening the bus bar and the connection object together such that the first connection surface and the second connection surface are pressed against each other,
wherein the bus bar includes a first base member made of aluminum, and a copper piece of plate shape that is joined to the first base member by metallic bonding and that forms the first connection surface,
the connection object includes a second base member made of aluminum, and the second connection surface is formed of the second base member,
the first connection surface has a projection projecting toward the second connection surface, and
when the bus bar and the connection object are fastened together with the bolt, the projection makes contact with the second base member with the first connection surface and the second connection surface being covered by the potting member, so that the first base member and the second base member are electrically connected to each other.

The present invention provides a bus bar to be fastened to a connection object, the bus bar comprising:
a first base member made of aluminum; and
a copper piece of plate shape that is joined to the first base member by metallic bonding,
wherein the copper piece has a first connection surface to be connected to the connection object,
the first connection surface has a projection projecting toward the connection object, and
when the bus bar is fastened to the connection object, the projection of the first connection surface makes contact with the connection object, so that the bus bar is electrically connected to the connection object.

The present invention provides a connector comprising the bus bar described above.

### BRIEF DESCRIPTION OF THE DRAWINGS

FIG. 1 is a photograph showing two bus bars whose contact resistance is being measured.

FIG. 2 is a graph showing measurement results of contact resistances.

FIG. 3 is a cross-sectional view showing a connection structure according to an embodiment of the invention.

FIG. 4 is an exploded view of the connection structure according to the embodiment.

FIG. 5 is an enlarged partial cross-sectional view showing a first base member and a copper piece of a first bus bar.

FIG. 6 is perspective view showing the first base member being disposed on an anvil for ultrasonic welding and in a fixing jig in production of the first bus bar.

FIG. 7 is a perspective view showing a copper piece being disposed on a surface of the first base member in production of the first bus bar.

FIG. 8 is a perspective view showing a horn for ultrasonic welding being disposed on the copper piece in production of the first bus bar.

FIG. 9 is a perspective view showing a welding action surface of the horn for ultrasonic welding.

FIG. 10 is a perspective view showing the state where the copper piece is ultrasonic-welded to the surface of the first base member in production of the first bus bar.

FIG. 11 is a partial perspective view showing a surface of the ultrasonic-welded copper piece.

FIG. 12 is a photograph showing part of the surface of the ultrasonic-welded copper piece.

FIG. 13 is a perspective view showing the state where a second bus bar is positioned on the first bus bar.

FIG. 14 is a perspective view showing the first bus bar and the second bus bar that are fastened by bolting.

FIG. 15 is a perspective view showing the state where three second bus bars are separately fastened to three first bus bars by bolting in a connector.

FIG. 16 is a cross-sectional view showing a conventional connection structure.

FIG. 17 is a partial cross-sectional view schematically showing the interface between a first bus bar and a second bus bar in the conventional connection structure.

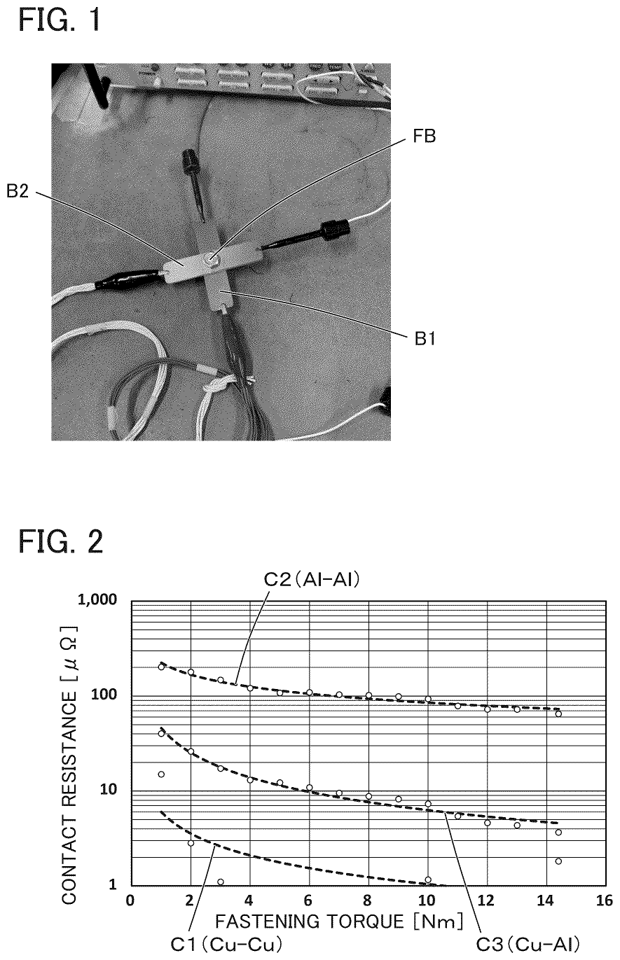

### DETAILED DESCRIPTION OF THE INVENTION

An embodiment of the invention is described below based on the accompanying drawings.

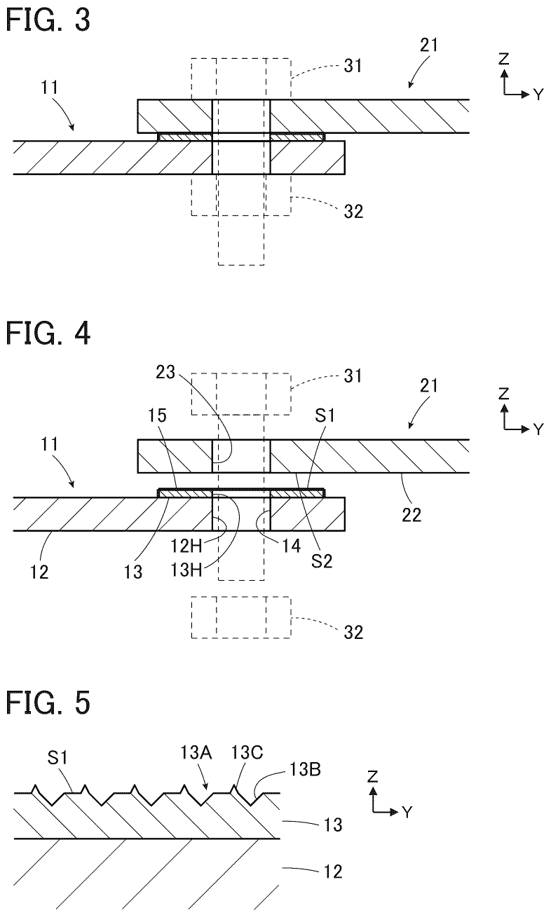

FIG. 3 shows a connection structure according to the embodiment of the invention. The connection structure includes a first bus bar 11 and a second bus bar 21 that extend in a predetermined direction, and a bolt 31 and a nut 32 that are used to fasten the first bus bar 11 and the second bus bar 21 together. The first bus bar 11 constitutes a “bus bar” of the invention, and the second bus bar 21 constitutes a “connection object” of the invention.

For convenience, the direction in which the first bus bar 11 and the second bus bar 21 extend is defined as “Y direction,” the direction in which the bolt 31 extends as “Z direction,” and the direction that is perpendicular to both the Y direction and the Z direction and is a width direction of the first and second bus bars 11 and 21 as “X direction.”

As shown in FIG. 4, the first bus bar 11 includes a first base member 12 of flat plate shape that is made of aluminum, and a copper piece 13 of plate shape that is joined to the surface of the first base member 12 on the +Z direction side. A through hole 12H is formed in the first base member 12, a through hole 13H having the same size as the through hole 12H of the first base member 12 is formed in the copper piece 13 coaxially with the through hole 12H, and those through holes 12H and 13H form a first through hole 14 that penetrates the first bus bar 11 in the Z direction to allow the bolt 31 to penetrate therethrough.

In addition, the surface of the copper piece 13 on the +Z direction side forms a first connection surface S1, and a potting member 15 is applied on the entire first connection surface S1.

Meanwhile, the second bus bar 21 includes a second base member 22 of flat plate shape that is made of aluminum. The second bus bar 21 is provided with a second through hole 23 penetrating the second base member 22 in the Z direction to allow the bolt 31 to penetrate therethrough.

In addition, the surface of the second base member 22 on the −Z direction side in a portion facing the first connection surface S1 of the first bus bar 11 forms a second connection surface S2.

As shown in FIG. 5, the surface of the copper piece 13 on the −Z direction side is joined to the first base member 12 by metallic bonding. In other words, copper atoms constituting the copper piece 13 are joined to aluminum atoms constituting the first base member 12 by metallic bonding at the interface between the first base member 12 and the copper piece 13, and no oxide coating is present between the first base member 12 and the copper piece 13.

An uneven shape portion 13A is formed at the surface of the copper piece 13 on the +Z direction side which forms the first connection surface S1. The uneven shape portion 13A includes a plurality of recesses 13B aligned, and a plurality of projections 13C aligned to be adjacent to the recesses 13B and projecting in the +Z direction. The end of the projection 13C has a sharp shape toward the +Z direction.

In general, copper has a higher hardness than aluminum. Thus, when the first bus bar 11 and the second bus bar 21 are fastened together such that the first connection surface S1 and the second connection surface S2 are pressed against each other, the projections 13C formed on the first connection surface S1 break an oxide coating formed on the second connection surface S2 of the second base member 22 in the second bus bar 21 and make direct contact with the second base member 22. When a fastening torque is increased, the projections 13C not only break the oxide coating but also bite into the inside of the second base member 22.

Next, a method of producing the first bus bar 11 configured as above is described.

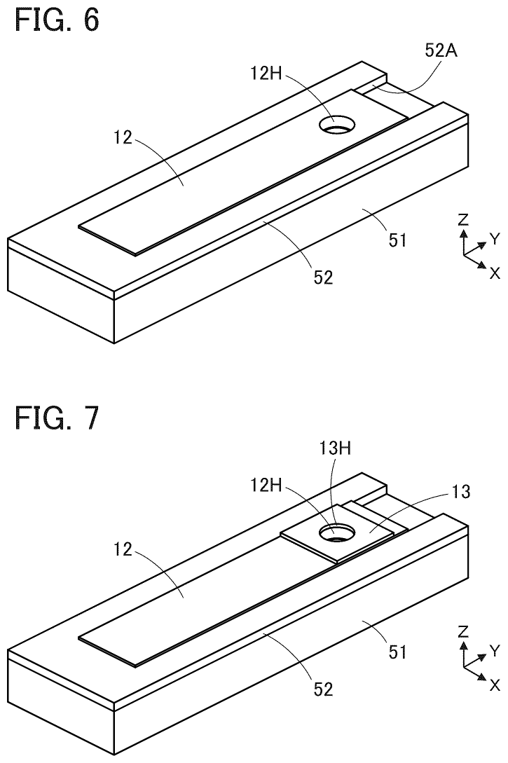

As shown in FIG. 6, a fixing jig 52 is disposed on an anvil 51 for ultrasonic welding. The fixing jig 52 has a cutout portion 52A to accommodate the first base member 12 of flat plate shape, and the first base member 12 is fixed on the surface of the anvil 51 for ultrasonic welding on the +Z direction side by being accommodated in the cutout portion 52A of the fixing jig 52.

Next, as shown in FIG. 7, the copper piece 13 is disposed on the surface of the first base member 12 on the +Z direction side. In this process, the copper piece 13 is disposed on the first base member 12 while being positioned with respect to the first base member 12 such that the through hole 13H of the copper piece 13 is situated right above the through hole 12H of the first base member 12.

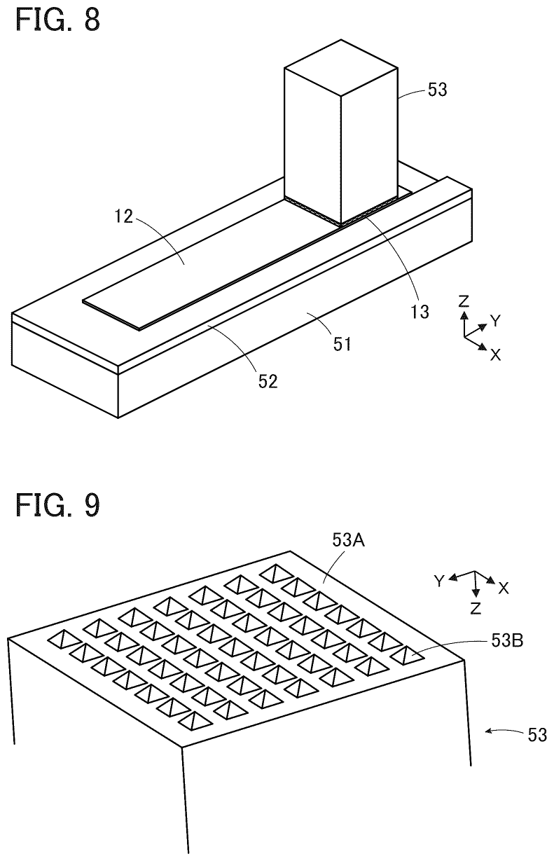

Further, a horn 53 for ultrasonic welding is disposed on the copper piece 13 as shown in FIG. 8. A −Z directional end portion of the horn 53 for ultrasonic welding is provided with a welding action surface 53A of flat shape extending along an XY plane as shown in FIG. 9. The welding action surface 53A has a shape and size corresponding to the copper piece 13 and is provided with a plurality of protrusion portions 53B that are aligned in the X direction and the Y direction and have the shape of a quadrangular pyramid protruding in the −Z direction.

For instance, the protrusion portions 53B are aligned at a pitch of 0.3 to 2.5 mm or thereabout in each of the X direction and the Y direction, and each protrusion portion 53B has such a shape that four triangular lateral surfaces constituting the quadrangular pyramid rise at a 45 degree angle with respect to the welding action surface 53A, and has a height of 0.15 to 0.8 mm from the welding action surface 53A toward the-Z direction. However, the alignment pitch, the rising angle, and the height as above are only examples and can be changed as appropriate according to, for instance, the size of the copper piece 13.

With the welding action surface 53A as above being in contact with the copper piece 13, ultrasonic vibrations are applied to the horn 53 for ultrasonic welding while the horn 53 for ultrasonic welding is pressurized toward the −Z direction. The ultrasonic vibrations applied to the horn 53 for ultrasonic welding are transmitted from the welding action surface 53A of the horn 53 for ultrasonic welding to the copper piece 13 and propagate inside the copper piece 13 to generate friction between the surface of the copper piece 13 on the −Z direction side and the surface of the first base member 12 on the +Z direction side. Consequently, oxide coatings formed on the surfaces of the first base member 12 and the copper piece 13 that are in contact are broken, and aluminum atoms constituting the first base member 12 and copper atoms constituting the copper piece 13 are mixed together and joined to each other by metallic bonding.

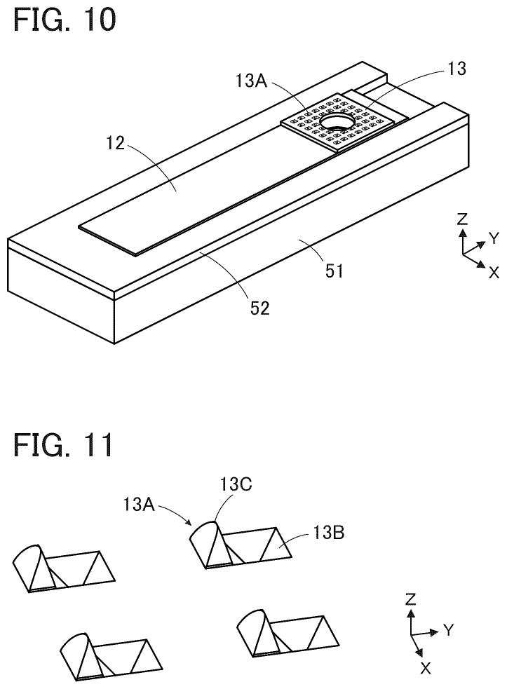

At the same time, the ultrasonic vibrations applied to the horn 53 for ultrasonic welding cause friction also between the welding action surface 53A of the horn 53 for ultrasonic welding and the surface of the copper piece 13 on the +Z direction side, and as a result, the uneven shape portion 13A is formed at the surface of the copper piece 13 on the +Z direction side as shown in FIG. 10. The uneven shape portion 13A is formed as a trace of the ultrasonic welding of the copper piece 13 to the first base member 12. In other words, the protrusion portions 53B in a quadrangular pyramid shape formed on the welding action surface 53A of the horn 53 for ultrasonic welding bite into the surface of the copper piece 13, whereby the shape of the protrusion portions 53B is transferred to the copper piece 13, and as shown in FIG. 11, the recesses 13B in a quadrangular pyramid shape are formed at the surface of the copper piece 13.

In addition, the projection 13C adjacent to each recess 13B and projecting in the +Z direction is formed as part of the uneven shape portion 13A. The projection 13C is formed probably because copper that was present in the portion corresponding to the recess 13B is raised when the recess 13B is formed by the protrusion portion 53B of the horn 53 for ultrasonic welding.

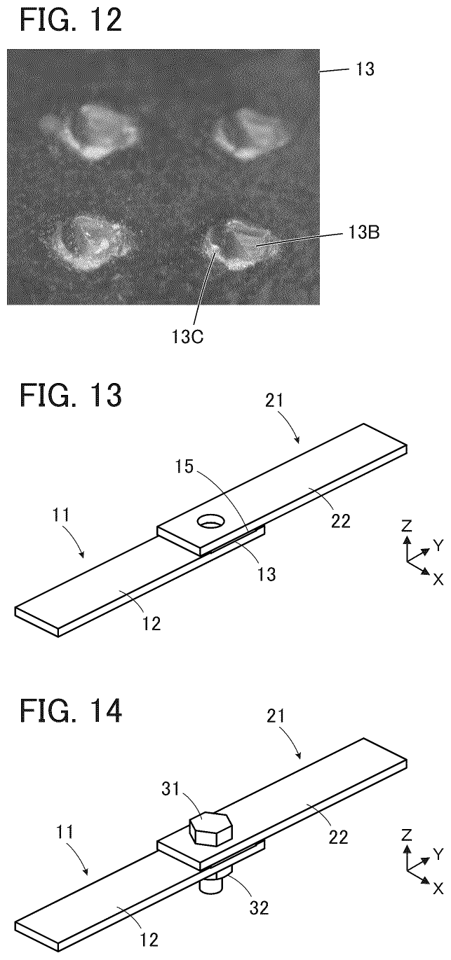

FIG. 12 shows a photograph of the surface of the copper piece 13 on the +Z direction side after ultrasonic welding was actually performed. It can be seen that the projections 13 are formed at positions adjacent to the respective recesses 13B.

The production of the first bus bar 11 is thus completed.

When the second bus bar 21 is connected to the first bus bar 11, first, the potting member 15 is applied onto the entire first connection surface S1 formed from the surface, on the +Z direction side, of the copper piece 13 of the first bus bar 11, and the second bus bar 21 is positioned on the +Z direction side of the first bus bar 11 while the second connection surface S2 is made contact with the first connection surface S1 via the potting member 15, as shown in FIG. 13.

The potting member 15 is used to protect the first connection surface S1 and the second connection surface S2 such that oxygen is prevented from entering between the first connection surface S1 and the second connection surface S2 after the first bus bar 11 and the second bus bar 21 are connected. As the potting member 15, various general-purpose potting materials intended for protection of electronic components and improvement in durability, such as epoxy resin, polyurethane, silicone, and acrylic can be used.

Subsequently, as shown in FIG. 14, the first bus bar 11 and the second bus bar 21 are fastened together with the bolt 31 and the nut 32, whereby the connection structure shown in FIG. 3 can be obtained. In this process, the bolt 31 is sequentially passed through the second through hole 23 of the second base member 22 of the second bus bar 21 and the first through hole 14 of the first bus bar 11 and fastened with the nut 32 as shown in FIG. 4.

Here, the projections 13C having sharp ends are formed on the surface of the copper piece 13 on the +Z direction side which forms the first connection surface S1 of the first bus bar 11. Hence, when the first bus bar 11 and the second bus bar 21 are fastened together with the bolt 31 and the nut 32, an oxide coating formed on the second connection surface S2 of the second base member 22 made of aluminum in the second bus bar 21 is broken by the projections 13C of the first bus bar 11, and the projections 13C make direct contact with the second bus bar 22.

In addition, the surface of the copper piece 13 on the −Z direction side is joined to the first base member 12 of the first bus bar 11 by metallic bonding.

Accordingly, the first base member 12 of the first bus bar 11 is electrically connected to the second base member 22 of the second bus bar 21 via the copper piece 13.

In other words, even though the first base member 12 of the first bus bar 11 and the second base member 22 of the second bus bar 21 are both made of aluminum, the connection between the first bus bar 11 and the second bus bar 21 with a low contact resistance is possible.

Further, since the potting member 15 is applied between the first connection surface S1 of the first bus bar 11 and the second connection surface S2 of the second bus bar 21, oxygen is prevented from entering between the first connection surface S1 and the second connection surface S2 owing to the potting member 15, and the low contact resistance can be maintained over a long period of time.

While the potting member 15 is applied on the first connection surface S1 of the first bus bar 11 in the above embodiment, the invention is not limited thereto, and the first bus bar 11 and the second bus bar 21 may be fastened together with the potting member 15 being applied onto the second connection surface S2 of the second bus bar 21 instead of the first connection surface S1.

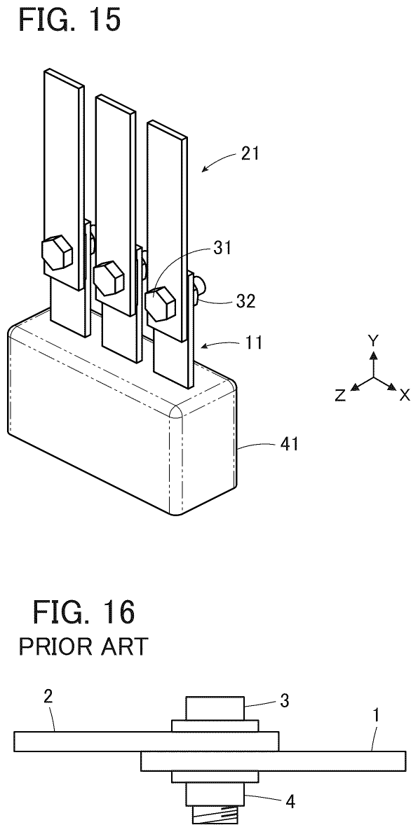

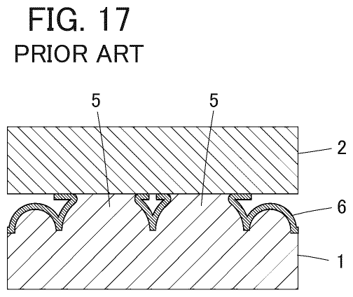

FIG. 15 shows a connector having the first bus bars 11. The connector has, for example, three first bus bars 11 retained in a housing 41 made of an insulating material. The second bus bar 21 can be fastened to each of the three first bus bars 11 with the bolt 31 and the nut 32. It should be noted that the first bus bar 11 and the second bus bar 21 need to be fastened together after the potting member 15 is applied onto the first connection surface S1 of the first bus bar 11 or the second connection surface S2 of the second bus bar 21.

The number of the first bus bars 11 is not limited to three.

The invention is not limited to the connection between the first bus bar 11 and the second bus bar 21 and is also applicable to a connection structure in which, in place of the second bus bar 21, a connection object such as a terminal having a second base member made of aluminum is used, and a bus bar is connected to the connection object, the bus bar being formed of a first base member made of aluminum to which a copper piece of plate shape is joined by metallic bonding as with the first bus bar 11 above.

What is claimed is:

1. A connection structure in which a first connection surface of a bus bar and a second connection surface of a connection object are connected to each other, the connection structure comprising:
a potting member applied between the first connection surface and the second connection surface; and
a bolt fastening the bus bar and the connection object together such that the first connection surface and the second connection surface are pressed against each other,
wherein the bus bar includes a first base member made of aluminum, and a copper piece of plate shape that is joined to the first base member by metallic bonding and that forms the first connection surface,
the connection object includes a second base member made of aluminum, and the second connection surface is formed of the second base member,
the first connection surface has a projection projecting toward the second connection surface, and
when the bus bar and the connection object are fastened together with the bolt, the projection makes contact with the second base member with the first connection surface and the second connection surface being covered by the potting member, so that the first base member and the second base member are electrically connected to each other.

2. The connection structure according to claim 1,
wherein the first connection surface has an uneven shape portion that is a trace of ultrasonic welding of the copper piece to the first base member, and the projection is formed of part of the uneven shape portion.

3. The connection structure according to claim 1,
wherein the bolt is passed through a first through hole penetrating the bus bar through the first connection surface and passed through a second through hole penetrating the connection object through the second connection surface.

4. A bus bar to be fastened to a connection object, the bus bar comprising:
a first base member made of aluminum; and
a copper piece of plate shape that is joined to the first base member by metallic bonding,
wherein the copper piece has a first connection surface to be connected to the connection object,
the first connection surface has a projection projecting toward the connection object, and
when the bus bar is fastened to the connection object, the projection of the first connection surface makes contact with the connection object, so that the bus bar is electrically connected to the connection object.

5. The bus bar according to claim 4,
wherein the copper piece is ultrasonic-welded to the first base member and thereby joined to the first base member by metallic bonding.

6. The bus bar according to claim 5,
wherein the first connection surface has an uneven shape portion that is a trace of ultrasonic welding of the copper piece to the first base member, and
the projection is formed of part of the uneven shape portion.

7. The bus bar according to claim 4,
wherein the bus bar has a first through hole that passes through the first connection surface and that allows a bolt to penetrate the bus bar, the bolt being used to fasten the bus bar to the connection object.

8. A connector comprising the bus bar according to claim 4.
